(19) United States
(12) Patent Application Publication
(10) Pub. No.: US 2007/0057788 A1
(43) Pub. Date: Mar. 15, 2007

(54) Seal

(76) Inventor: Ke-Hsiao Wu, Yuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/223,110

(22) Filed: Sep. 12, 2005

(51) Int. Cl. G08B 13/14

(52) U.S. Cl. 340/572.1

(57) ABSTRACT

A new seal comprising a base formed into a flat rectangular box with a raised seal body in the center of its sealed wall; a cover in accordance with a first opening wall of said base to be combined with said base together as a whole; a U-shaped resilient shackle having a first, second hook at two reversely bent end portions to thread through an aperture of said base and engage a first, second shoulder of said seal body and a chip embedded in a suitable place of said base to send out the radio frequency energy and receive the identification code.

### BACKGROUND OF THE INVENTION

1. Field of the Invention

The present invention relates to a seal and more particularly to a new seal comprising a base formed into a flat rectangular box. The base has a raised seal body in the center of its sealed wall. A cover is made for a first opening surface of the base. A resilient shackle made of wire is U-shaped with a first, second hook inwardly extending at two reversely bent end portions. The first, second hook is adapted to engage a first, second shoulder when inserted into the seal body. A chip is embedded in the base for radiating the radio frequency energy and receiving the identification code. Therefore, the object in this seal of the present invention is easy to be traced as the seal is coupled to a radio frequency identification device.

2. Prior Art

There are numerous types of seal assemblies known in the art and especially most of them are trying to improve the inner construction and avoid any opportunities of being opened. However, some seals are even intact but without any apparent evidences of tampering.

### OBJECTS OF THE INVENTION

The main purpose of the present invention is to provide a new seal which has a chip embedded in the base. The chip is used as a reader for radiating the certain radio frequency energy to drive a transponder circuit sending out a specific identification code in its internal processor; in that case, the reader is allowed to identify the transponder and reaches the result of determining the position of the object in this seal of the present invention.

### BRIEF DESCRIPTION OF THE DRAWINGS

These and other features, aspects and advantages of the present invention will become apparent from the following description, claims and the accompanying embodiment shown in the drawing, which is briefly described below.

FIG. 1 is an appearance view of the present invention;

FIG. 2 is an exploded view of every part of FIG. 1 according to the present invention.

FIG. 3 is an elevation view of the present invention in a non-locking stage of use;

FIG. 4 is an elevation view of FIG. 3 in a locked mode.

### DESCRIPTION OF THE REFERRED EMBODIMENT

Referring to the drawings of FIG. 1 to FIG. 4, a new seal according to the present invention comprises a base 1, a cover 2, a resilient shackle 3 and a chip 17. The base 1 might be formed into a box body with appropriate shape. In the embodiment of the present invention, the base 1 is formed into a flat rectangular box. A first opening wall of the base 1 is combined with the cover 2 together. A raised seal body 6 is set in the center of a second sealed wall 4 of the base 1. The height of the seal body 6 is lower than the height of side walls 5 of the base 1. Appropriately slant guided slots 11 are at two top sides of the seal body 6 and the slant guided slots 11 have a first, second shoulder 9 and 10 at two sides of its lower portion. A first, second hook 7 and 8 of a resilient shackle 3 is designed to engage the first, second shoulder 9 and 10 when inserted into the seal body 6 to form an unbreakable hook. On the top side wall 5 of the base 1, an aperture 13 is provided for the first, second hook 7 and 8 of the resilient shackle 3 to thread through. A position cavity 14 on top end of the seal body 6 corresponding to a position member 15 of the cover 2 is used for positioning the base 1 and the cover 2 to combine them together.

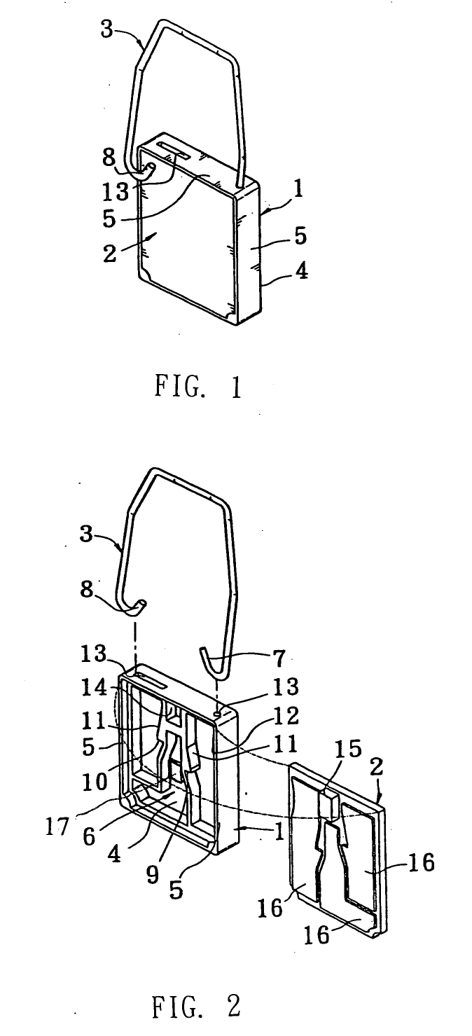

Referring to the drawings of FIG. 1 and FIG. 2, a cover 2 is in accordance with the first opening wall of the base 1 to be combined with the base 1 together as a whole. Besides a position member 15 on the internal wall of the cover 1, there are also land portions 16 in accordance with lower portions of the base 1. After the cover 2 is combined with the first opening wall of the base 1, the first, second hook 7 and 8 of the resilient shackle 3 can only move within the recess of two lower portions to prevent the hooks 7 and 8 turning around or separating from the shoulders 9 and 10 as engaging the shoulders 9 and 10.

The resilient shackle 3 of the present invention is made of resilient wire having great thickness and elasticity to be bent into the U shape. The first, second hook 7 and 8 are inwardly extending at two reversely bent end portions. The width of the first, second hook 7 and 8 is slightly wider than the width of the space at two sides of the seal body 6 in the base 1 and also flange 12 is set on side walls 5 of the base 1 so that the hooks 7 and 8 are not easy to loose from the shoulders 9 and 10 after being pressed to thread through the aperture 13 of the base 1.

The chip 17 of the present invention is embedded in a suitable place of the sealed wall 4 of the base 1 and used as a reader for radiating the certain radio frequency energy to drive a transponder circuit sending out a specific identification code in its internal processor; in that case, the reader is allowed to identify the transponder and reaches the result of determining the position of the object in this seal.

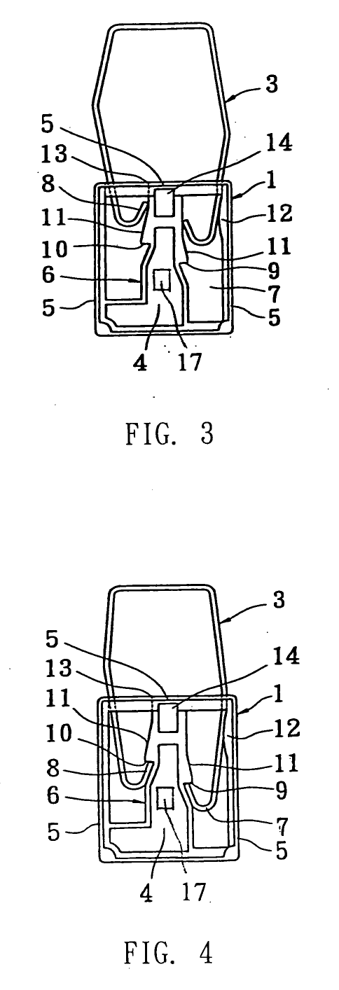

The usage of the present invention is to place the first hook 7 of the resilient shackle 3 in the base 1 in advance (as shown in FIG. 1) and thread the second hook 8 of the resilient shackle 3 through the aperture 13 of the base 1 (as shown in FIG. 3) after the second hook 8 is inserted through the desired object. Then, adjust the first, second hook 7 and 8 of the resilient shackle 3 to engage the first, second shoulder 9 and 10 of the seal body 6 forming an unbreakable hook. At the same time, the chip 17 in the base 1 sends out the certain radio frequency energy and receives the identification code to determine the position of the object in this seal.

I claim:

1. A new seal, comprising:
(a) a base formed into a flat rectangular box having a first opening wall for combining with a cover as a whole, a raised seal body set in the center of a second sealed wall of said base, said raised seal body lower than side walls of said base and formed with said sealed wall as a whole, a position cavity seated on the top of said seal body, slant guided slots at two top sides of said seal body moving relatively as a first, second hook of a resilient shackle being inserted into said seal body, a first, second shoulder at two sides of the lower portion of said guided slots engaging said hooks, an aperture on the top side wall of said base provided for said hooks to thread through after said second hook inserted through a desired object;
(b) a cover combined with said first opening wall of said base, a position member and land portions set on the internal wall of said cover, said position member corresponding to said position cavity of said base adapted to be inserted into said position cavity of said base and said land portions in accordance with said lower portions of said base so as to combine said cover with said first opening wall of said base together;
(c) a resilient shackle, made of resilient wire having great thickness and elasticity to be bent into a U shape, said resilient shackle having a first, second hook inwardly extending at two reversely bent end portions for threading through said apertures of said base and engaging said shoulders to form an unbreakable hook, and;
(d) a chip embedded in a suitable place of said sealed wall of said base and used as a reader for radiating the certain radio frequency energy to drive a transponder circuit sending out a specific identification code in its internal processor; in that case, the reader is allowed to identify the transponder and reaches the result of determining the position of the object in this seal of the present invention.
